(19) United States
(12) Patent Application Publication
(10) Pub. No.: US 2017/0309265 A1
(43) Pub. Date: Oct. 26, 2017

(54) Megaphone Device

(71) Applicant: Victor Ly, Philadelphia, PA (US)

(72) Inventor: Victor Ly, Philadelphia, PA (US)

(21) Appl. No.: 15/495,791

(22) Filed: Apr. 24, 2017

Related U.S. Application Data
(60) Provisional application No. 62/326,217, filed on Apr. 22, 2016.

(51) Int. Cl. G10K 11/08

(52) U.S. Cl. CPC G10K 11/08

(57) ABSTRACT

A megaphone device for amplifying sound is provided. The megaphone device comprises a flat foldable sheet having an inner surface, an outer surface, a mouth edge, a bell edge, a first side edge, and a second side edge. An adhesive strip is positioned along and nearingly adjacent the first side edge. A plurality of breakable fold over tabs is formed along the mouth edge with the fold over tabs movable in a general direction toward the outer surface to a position substantially perpendicular to the foldable sheet. The foldable sheet is rollable into a substantial cone shape forming a mouth portion along the mouth edge and a bell portion along the bell edge with the first side edge contacting the second side edge and the adhesive strip maintaining the substantial cone shape. Sounds projected through the mouth portion travel through a widening interior, and exit the bell portion at an increased volume.

### CLAIM OF PRIORITY

This patent application claims priority under 35 USC 119 (e) (1) from U.S. Provisional Patent Application Ser. No. 62/326,217 filed Apr. 22, 2016, of common inventorship herewith entitled, “The Cause Horn,” which is incorporated herein by reference as though the same were set forth in its entirety.

### FIELD OF THE INVENTION

The present invention pertains to the field of megaphone devices, and more specifically to the field of megaphone devices for amplifying sounds configured as a heavy flat sheet foldable into a horn shape and specifically contains integrated fold over tabs in its mouth portion.

### BACKGROUND OF THE INVENTION

Sports fans have myriad ways of expressing their love of a favorite team when attending a game. From constructing large, colorful banners that display support for a star player to composing elaborate cheers and rhymes, spectators at sporting events go the extra mile to show their appreciation. Whether college or professional, televised football contests are rife with camera shots of the spectator stands, showing the world just how serious fans are in their support of their team. Avid fans don reproductions of a favored player's football jersey or baseball shirt while some fans show their enthusiasm by painting their faces and even bodies with team colors. Wearing hats that are specially formed into symbolic representations of a team's mascot or home city is a popular display of team pride. With each new sporting season, fans of the sport seek different and spirited ways to convey their commitment to their favorite team.

The prior art has put forth several designs for megaphone devices. Among these are:

US Patent Publication 2007/0108258 to Michael Taylor and Erik Laibe describes a convertible container with the primary objective of providing a commercially viable container for the vending and serving of popcorn or similar food products while easily being converted to a megaphone for voice amplification with promotional and advertising applications. The Pophorn is manufactured from a single sheet of printable yet grease and moisture resistant material which is die cut and glued. The Pophorn has a rigid double layer spine over its entire length for support as a function of a continuation of the complimentary handle of the container or megaphone.

U.S. Pat. No. 8,191,673 to Scott Peaslee describes a collapsible megaphone device having a body portion capable of lying flat in a first state and capable of assuming the shape of a megaphone in a second state. In the first state, the collapsible megaphone device is substantially two dimensional and planar having a first edge, second edge and boundary edges joining the first and second edges. The collapsible megaphone device is convertible from the first state to the second state by exerting pressure against its boundary edges and is returnable to the first state by removing pressure from its boundary edges.

U.S. Pat. No. 1,613,001 to John Walter Wilhelm describes a megaphone formed from a single sheet of cardboard. The megaphone tapers in size and is oblong shaped in transverse cross section. The side walls are wider than the other walls thereof. The other walls are foldable onto the inner sides of the wide walls, so the megaphone is foldable into a flat condition.

U.S. Pat. No. 763,808 to Hollister Sturges describes a megaphone adapted to be collapsed and folded into comparatively little space for convenient storing aboard ship or other place and adapted to be quickly and readily extended for use. The collapsible megaphone comprises a body in the form of a split truncated cone, a ring in the apex end of the body, and means for locking and unlocking the sides of the cone at its split, said means being adapted to bring the edges of the cone at its split, into abutting engagement with each other.

None of these prior art references describe the present invention.

### SUMMARY OF THE INVENTION

It is an object of the present invention to provide an amplifying horn that is configured as a heavy flat sheet that is foldable into a horn shape and specifically contains integrated fold over tabs in its mouth portion.

The present invention is a megaphone device for amplifying sound. The megaphone device comprises a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge. An adhesive strip is positioned along and nearingly adjacent the first side edge of the foldable sheet. A plurality of breakable fold over tabs is formed along the mouth edge of the foldable sheet with the fold over tabs movable in a general direction toward the outer surface of the foldable sheet to a position substantially perpendicular to the foldable sheet. The foldable sheet is rollable into a substantial cone shape forming a mouth portion along the mouth edge and a bell portion along the bell edge with the first side edge contacting the second side edge and the adhesive strip maintaining the substantial cone shape. Sounds projected through the mouth portion travel through a widening interior, and exit the bell portion at an increased volume.

In addition, the present invention includes a method for amplifying sound. The method comprises providing a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge, positioning an adhesive strip along and nearingly adjacent the first side edge of the foldable sheet, forming a plurality of breakable fold over tabs along the mouth edge of the foldable sheet, rolling the foldable sheet into a substantial cone shape forming a mouth portion along the mouth edge and a bell portion along the bell edge with the first side edge contacting the second side edge and the adhesive strip maintaining the substantial cone shape, moving the fold over tabs in a general direction toward the outer surface of the foldable sheet to a position substantially perpendicular to the foldable sheet, projecting sounds through the mouth portion, and increasing volume of the sounds as the sounds exit the bell portion.

The present invention further includes a megaphone device for amplifying sound. The megaphone device comprises a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge. At least one vertical fold line extends between the mouth edge and the bell edge of the foldable sheet. An adhesive strip is positioned along and nearingly adjacent the first side edge of the foldable sheet. A plurality of breakable fold over tabs is formed along the mouth edge of the foldable sheet with the fold over tabs movable in a general direction toward the outer surface of the foldable sheet to a position substantially perpendicular to the foldable sheet thereby creating a mouthpiece platform. The foldable sheet is rollable into a substantial cone shape forming a mouth portion along the mouth edge and a bell portion along the bell edge with the first side edge contacting the second side edge and the adhesive strip maintaining the substantial cone shape. Sounds projected through the mouth portion travel through a widening interior, and exit the bell portion at an increased volume.

### BRIEF DESCRIPTION OF THE DRAWINGS

FIG. 1 is a perspective view illustrating a megaphone device, constructed in accordance with the present invention, showing a flat sheet of material with a peel back adhesive strip running vertically along a length of an outer edge.

FIG. 2 is a perspective view illustrating the megaphone device, constructed in accordance with the present invention, with the flat sheet of material folded properly in a fully functional state, showing the wider ended opening and the lengthier outer edges sealed together securely by means of the peel back adhesive strip shown in FIG. 1.

FIG. 3 is a perspective view illustrating the megaphone device, constructed in accordance with the present invention, with the flat sheet of material folded properly in a fully functional state, showing the smaller ended opening with tabs folded over for safe use and the lengthier outer edges sealed together securely by means of the peel back adhesive strip shown in FIG. 1.

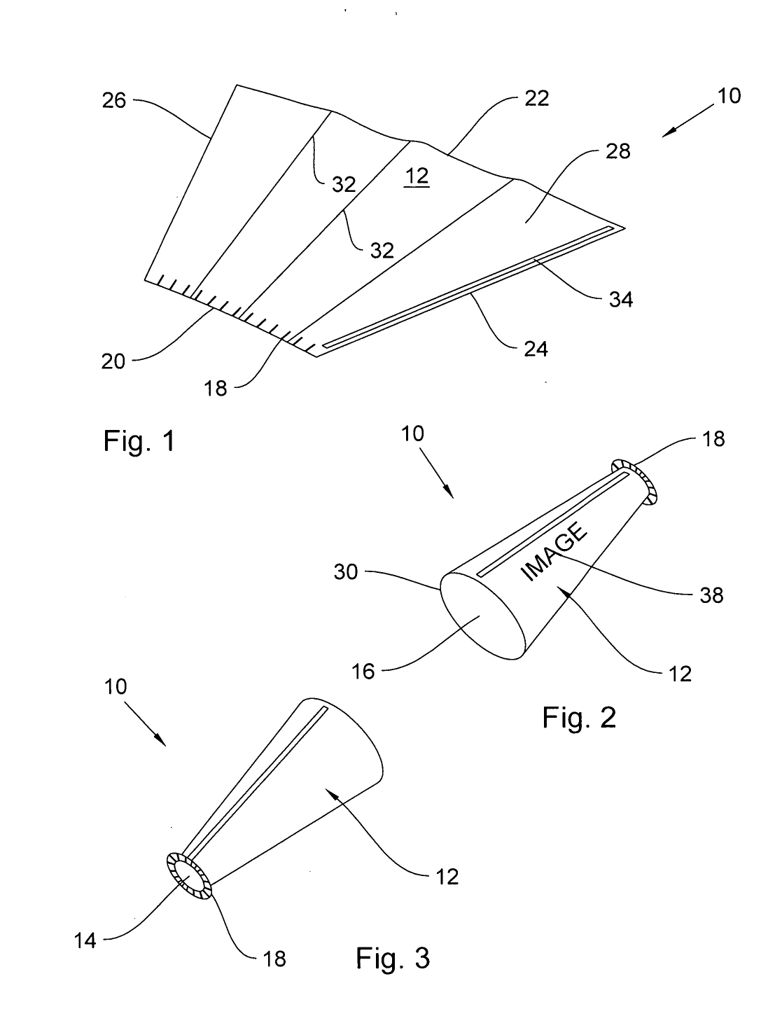

### DETAILED DESCRIPTION OF THE INVENTION

The present invention, hereinafter referred to as a Megaphone Device, indicated generally at 10, is an amplifying horn configured as a heavy flat sheet 12 foldable into a horn shape having a mouth portion 14 (small opening) and a bell portion 16 (large opening) and specifically including integrated fold over tabs 18 formed at the mouth portion 14. The fold over tabs 18 enable an individual to safely press their lips against the mouth portion 14 of the Megaphone Device 10, eliminating any risk of cutting one's lips. Using the Megaphone Device 10 increases the volume of an individual's voice at sporting or other high spirited events while conveying an endless variety of visual messages.

The foldable sheet 12 of the Megaphone Device 10 of the present invention has a mouth edge 20 (which forms the mouth portion 14), a bell edge 22 (which forms the bell portion 16) substantially opposite the mouth edge 20, a first side edge 24 between the mouth edge 20 and the bell edge 22, and a second side edge 26 substantially opposite the first side edge 24. The foldable sheet 12 also has an outer surface 28 and an inner surface 30 substantially opposite the outer surface 28.

The foldable sheet 12 of the Megaphone Device 10 of the present invention preferably includes at least one, preferably a series of, spaced, vertical fold lines 32 extending between the mouth edge 20 and the bell edge 22 of the foldable sheet 12. The fold lines 32 provide a guide to a user in folding the foldable sheet 12 so that it forms a conically-shaped megaphone accessory.

The foldable sheet 12 of the Megaphone Device 10 of the present invention is preferably constructed of a single sheet of flat heavy duty paperboard or vinyl sheet. It should be noted that while the foldable sheet 12 has been described and illustrated as being constructed from a single sheet of a particular material, it is within the scope of the present invention to construct the foldable sheet 12 from multiple sheets and from different materials.

In addition, the Megaphone Device 10 of the present invention includes an adhesive strip 34 positioned on the inner surface 30 of the foldable sheet 12 along and nearingly adjacent the first side edge 24 or the second side edge 26 of the foldable sheet 12. Preferably, the adhesive strip 34 is covered in a releasable, peel away paper backing 36 which is removable to expose the adhesive strip 34 thereby allowing the user to seal the inner surface 30 of the foldable sheet 12 along the first side edge 24 of the foldable sheet 12 to the outer surface 28 of the foldable sheet 12 along second side edge 26 of the foldable sheet 12, or vice versa, to form the Megaphone Device 10 in its properly functioning megaphone shape.

Furthermore, the Megaphone Device 10 of the present invention includes the plurality of breakable fold over tabs 18 formed along the mouth edge 20 of the foldable sheet 12 and movable in a general direction toward the outer surface 28 of the foldable sheet 12. When the foldable sheet 12 is secured in its usable megaphone shape and secured along the adhesive strip 34, the tabs 18 create a comfortable mouthpiece platform for resting against the lips of the user without injury.

In a preferred embodiment, at least the outer surface 28 of the foldable sheet 12 of the Megaphone Device 10 of the present invention is imprinted with eye catching images 38, sports logos, advertisements, and cause related promotions. The available images include the logos and colors of all professional, college or high school teams including football, baseball, soccer, and hockey. The images 38 of the Megaphone Device 10 line include international sporting organizations, namely teams of global football or soccer, rugby, cricket, and Grand Prix. The Megaphone Device 10 is employed to display images such as advertisements and cause related event promotions and reminders. These ads include local and national businesses and charities.

The Megaphone Device 10 of the present invention works in a manner similar to a nonelectrical megaphone. Sounds are projected through the mouth portion 14 (proximal small opening), travel through a widening interior of the Megaphone Device 10, and exit the bell portion 16 (distal end) at an increased volume.

Using the Megaphone Device 10 of the present invention is simple and straightforward. A user selects a foldable sheet 12 containing images 38 and logo they wish to support and promote. The user folds the foldable sheet 12 along the fold lines 32 into the shape of a cheering megaphone, sealing it in a securely closed position by means of an adhesive strip 34 running vertically along either the first side edge 24 or the second side edge 26 of the foldable sheet 12. The user folds the breakable tabs 18 formed at the mouth edge 20 of the foldable sheet 12 in a position substantially perpendicular to the foldable sheet 12 of the Megaphone Device 10.

The user then holds the proximal end of the Megaphone Device 10 of the present invention with one or both hands. The user raises the Megaphone Device 10 into the air with its wide distal bell portion 16 facing upward towards the sky or dome of the stadium. The user then places their mouth at the mouth portion 14 of the Megaphone Device 10 and audibly yells into the megaphone horn, sending amplified soundwaves to cheer for their team.

The Megaphone Device 10 of the present invention provides sports enthusiasts with a simple, attractive means of louder celebrating while enjoying games in a noisy arena. Lifting one's voice higher than others, the megaphone device 10 ensures that a fan's vocal appreciation is easily heard over surrounding cacophony. This functional advantage is especially effective for children and enables them to fully be a part of the festivities. A highly visible and audible means of supporting a much loved team and players, the Megaphone Device 10 functions extremely well for adults and children alike. Durably constructed of high quality materials, the Megaphone Device 10 will withstand many years of games and events which promote crowd cheering support.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A megaphone device for amplifying sound, the megaphone device comprising:
a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge;
an adhesive strip positioned along and nearingly adjacent the first side edge of the foldable sheet; and
a plurality of breakable fold over tabs formed along the mouth edge of the foldable sheet, the fold over tabs movable in a general direction toward the outer surface of the foldable sheet to a position substantially perpendicular to the foldable sheet;
wherein the foldable sheet is rollable into a substantial cone shape forming a mouth portion along the mouth edge and a bell portion along the bell edge, the first side edge contacting the second side edge, the adhesive strip maintaining the substantial cone shape; and
wherein sounds projected through the mouth portion travel through a widening interior, and exit the bell portion at an increased volume.

2. The megaphone device of claim 1 wherein the mouth portion has a first diameter and the bell portion has a second diameter, the first diameter being less than the second diameter.

3. The megaphone device of claim 1 and further comprising:
at least one vertical fold line extending between the mouth edge and the bell edge of the foldable sheet.

4. The megaphone device of claim 1 and further comprising:
a plurality of spaced, vertical fold lines extending between the mouth edge and the bell edge of the foldable sheet.

5. The megaphone device of claim 1 wherein the foldable sheet is constructed of a single sheet of flat heavy duty paperboard or vinyl sheet.

6. The megaphone device of claim 1 wherein the adhesive strip is positioned on the inner surface of the foldable sheet along and nearingly adjacent the first side edge, the adhesive strip contacting the outer surface of the foldable sheet along and nearingly adjacent the second side edge.

7. The megaphone device of claim 1 and further comprising:
a releasable, peel away paper backing positioned over the adhesive strip.

8. The megaphone device of claim 1 wherein the foldable tabs create a mouthpiece platform.

9. The megaphone device of claim 1 and further comprising:
at least one image imprinted on the foldable sheet and visible upon rolling foldable sheet into the substantial cone shape.

10. The megaphone device of claim 9 wherein the at least one image is selected from the group consisting of sports logos, advertisements, and cause related promotions.

11. A method for amplifying sound, the method comprising:
providing a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge;
positioning an adhesive strip along and nearingly adjacent the first side edge of the foldable sheet;
forming a plurality of breakable fold over tabs along the mouth edge of the foldable sheet;
rolling the foldable sheet into a substantial cone shape forming a mouth portion along the mouth edge and a bell portion along the bell edge with the first side edge contacting the second side edge and the adhesive strip maintaining the substantial cone shape;
moving the fold over tabs in a general direction toward the outer surface of the foldable sheet to a position substantially perpendicular to the foldable sheet;
projecting sounds through the mouth portion; and
increasing volume of the sounds as the sounds exit the bell portion.

12. A megaphone device for amplifying sound, the megaphone device comprising:
a flat foldable sheet having an inner surface, an outer surface substantially opposite the inner surface, a mouth edge, a bell edge substantially opposite the mouth edge, a first side edge between the mouth edge and the bell edge, and a second side edge substantially opposite the first side edge;
at least one vertical fold line extending between the mouth edge and the bell edge of the foldable sheet;
an adhesive strip positioned along and nearingly adjacent the first side edge of the foldable sheet; and
a plurality of breakable fold over tabs formed along the mouth edge of the foldable sheet, the fold over tabs movable in a general direction toward the outer surface of the foldable sheet to a position substantially perpendicular to the foldable sheet, the foldable tabs creating a mouthpiece platform;
wherein the foldable sheet is rollable into a substantial cone shape forming a mouth portion along the mouth edge and a bell portion along the bell edge, the first side edge contacting the second side edge, the adhesive strip maintaining the substantial cone shape; and
wherein sounds projected through the mouth portion travel through a widening interior, and exit the bell portion at an increased volume.

13. The megaphone device of claim 12 wherein the mouth portion has a first diameter and the bell portion has a second diameter, the first diameter being less than the second diameter.

14. The megaphone device of claim 12 and further comprising:
a plurality of spaced, vertical fold lines extending between the mouth edge and the bell edge of the foldable sheet.

15. The megaphone device of claim 12 wherein the foldable sheet is constructed of a single sheet of flat heavy duty paperboard or vinyl sheet.

16. The megaphone device of claim 12 wherein the adhesive strip is positioned on the inner surface of the foldable sheet along and nearingly adjacent the first side edge, the adhesive strip contacting the outer surface of the foldable sheet along and nearingly adjacent the second side edge.

17. The megaphone device of claim 12 and further comprising:
a releasable, peel away paper backing positioned over the adhesive strip.

18. The megaphone device of claim 12 and further comprising:
at least one image imprinted on the foldable sheet and visible upon rolling foldable sheet into the substantial cone shape.

19. The megaphone device of claim 18 wherein the at least one image is selected from the group consisting of sports logos, advertisements, and cause related promotions.
